(19) United States
(12) Patent Application Publication
(10) Pub. No.: US 2012/0104054 A1
(43) Pub. Date: May 3, 2012

(54) Fluid safety dispenser

(76) Inventors: Robert Terwilliger, Palm Beach Gardens, FL (US); Paul Schlie, Durham, NH (US)

(21) Appl. No.: 13/169,732

(22) Filed: Jun. 27, 2011

Related U.S. Application Data
(63) Continuation-in-part of application No. 12/981,040, filed on Dec. 29, 2010.
(60) Provisional application No. 61/407,775, filed on Oct. 28, 2010.

(51) Int. Cl. B67D 7/06

(52) U.S. Cl. 222/563

(57) ABSTRACT

A fluid safety dispenser system having a fluid storage container keyed to a fluid dispenser. The container having a valve body positionable in the opening of the container, the valve body having a plug member biased to allow fluid passage through the opening of the container when in a displaced position and to eliminate fluid passage through the opening of the container when the plug member is in a seated position. The keyed fluid dispenser assimilates a syringe and is releasably securable to the valve body for use in depressing the plug member by movement of a biasing member when the keyed fluid dispenser is in position. The keyed fluid dispenser has indicia to provide for exact measurement and can be temporarily coupled to the container to provide ease of fluid transfer.

### PRIORITY CLAIM

This application is a continuation-in-part of U.S. patent application Ser. No. 12/981,040, filed Dec. 29, 2010, entitled “Fluid Safety Dispenser System”, which claims priority of U.S. Provisional Patent Application No. 61/407,775, filed Oct. 28, 2010, entitled “Fluid Safety Dispenser System,” the contents of the applications are incorporated herein by reference.

### FIELD OF THE INVENTION

This invention relates generally to fluid safety dispensers and, in particular, to a container having a fluid dispensing valve.

### BACKGROUND OF THE INVENTION

A problem exists in that an individual may access the contents of a container with little or no resistance. While child resistant containers exist, they are only secure if the closure top is installed properly. For instance, if the closure top is not properly engaged after opening, the safety aspect of the closure top is defeated and a child can easily access the contents. Further, once the cap is removed there is nothing to prevent the entire contents of the container from being poured out and ingested, e.g., by children who may not comprehend the threat of serious injury from improper use.

Even if the container is in the hands of a guardian, the guardian may not have a measuring cup or understand liquid conversions should the container require a measured amount, medication for instance. If a guardian is instructed to provide 20 ml of medication but has misplaced, or was not provided with, the measuring cup the guardian may assume 1 ounce (over dosing) or 1 tablespoon (under dosing) is acceptable. Similarly, a guardian only conversant in the English system may receive instructions in ml and attempt to estimate the equivalent in teaspoons. Another example would be if a guardian is instructed to provide two teaspoons but employs a tablespoon. It is not uncommon for someone to believe one tablespoon equals two teaspoons (under dosing). Further, the use of a teaspoon or tablespoon used for eating is not accurate as there is no required standard in the industry. Conventional eating spoons are shaped for aesthetic appearance, not for medical dosing.

Some containers rely upon the use of the container cap as a measuring cup; again the fluid dispensed from the container is estimated as it is not possible to end with full caps unless the dosing is rounded upward or downward. Medication containers may include a measurement container; however, they can be displaced or intermixed with other measuring containers, again risking improper dosing.

U.S. Pat. No. 3,240,373 discloses a container with a side type dispenser wherein a release lock tab prevents opening of the slide unless first released.

U.S. Pat. No. 3,160,301 discloses a container which uses a key and slot wherein the key is attached to an outer cap with a resilient, flexible strap.

U.S. Pat. No. 3,501,041 discloses a bottle cap having an inner cap member enclosed by a sleeve member, and connecting means carried by the members provides for relative rotational and axial movement there between. Engagement of a separable locking means with the cap and sleeve members locks the members against relative rotational movement and thus permits threaded engagement or disengagement of the cap from the bottle.

U.S. Pat. No. 3,684,115 discloses a safety container having a skirt with internal screw threads to form a conventional screw cap closure, and an overcap completely covering the threaded closure member and being freely rotatable in relationship thereto. The overcap has on its top a projecting stud and a similar shaped opening which serves as a key for unscrewing the inner closure member of another closure of similar construction.

U.S. Pat. No. 3,698,585 discloses an inner cap member adapted for being threaded onto the neck of a bottle for closing the opening therein. An outer cap member interlocks with the inner cap member when it is turned in a direction to apply the inner cap member to the bottle. When turned in the opposite direction, the outer cap member normally does not interlock with the inner cap member.

U.S. Pat. No. 3,869,058 discloses a safety closure for a container to prevent inadvertent opening of the container. The closure includes an inner cap having an internal threaded portion to be attached to the threads on the neck of the container and an outer cap overlying the inner cap. The top of the inner cap has a raised plate or ledge which is tapered and is provided with notches extending inwardly of the outer rim and a leaf spring centrally located on the top of the inner cap. The underside of the top of the outer cap has tracks to form a guideway and a stop. A slide is disposed on the guideway between the inner and outer cap and engages the stop to prevent lateral movement of the slide. When normally assembled, the outer cap will freely rotate around the inner cap without moving the inner cap. When the slide is depressed by pressure exerted through the aperture against the action of the leaf spring, the slide is moved to disengage the slot from the stop and partially out of the guideway.

U.S. Pat. No. 4,281,771 discloses a child-resistant cap closure with incorporated means for over-ride of conventional normally disengaged torque couplings which includes a hole formed in the top surface of the outer cap, a formed plug having a locking protuberance and removal ring, and a plurality of spaced stop lugs formed annularly on the top surface of the inner cap. The free and separate movement of the outer cap is prevented in either direction of rotation by the plug's insertion into the hole of the outer cap as to place the base of the plug in the space between the stop lugs of the inner cap, rendering the cap non-child-resistant at the time of consumer purchase.

U.S. Pat. No. 4,854,459 discloses a container having a cylindrical neck at the top and threads molded about the exterior of the neck, as well as an inner cap and outer cap. The inner cap has a top and cylindrical side wall with threads molded on the inside of the side wall so as to mate with the threads of the container. The top or side of the inner cap has ratchet type segments on its outside and the outer cap has ratchet type segments on the inside of its top or side. The outer cap has a cylindrical side wall and is usually freely rotatable about the inner cap so as to be childproof. When in the childproof configuration as described, downward pressure is required by the user so as to engage the two ratchet type segments and thereby engage the two caps to permit opening.

U.S. Pat. No. 5,115,928 discloses a child-resistant closure and shell. The shell mounts a latching key and the closure provides a complementary latch. An alignment structure provides for aligning the latch and key for movement of the latching key from a mode in which the key is inactive to a mode in which it engages the latch to inactivate the child-resistant function of the closure. In that position the shell and closure are movable in both clockwise and counter-clockwise directions. Leaf spring fingers may be provided to elevate the shell relative to the closure to provide an additional child-resistant function. The latching key may be hingedly or slideably secured to the shell.

U.S. Pat. No. 5,484,070 discloses a container having a syringe tip connector for coupling to a container, the device directed to aspirating medication into a syringe for oral administration to children, adults or animals.

U.S. Pat. No. 7,111,746 discloses a child resistant closure having a pair of nested inner and outer caps. The inner cap is coaxially positioned and nested within the outer cap such that a row of angular abutments on the inner cap engage a row of angular abutments on the outer cap when engaged to allow rotation of the cap.

While the prior art is directed to assuring that the consumer is knowledgeable of the proper amount of medication and the need for child resistant closures to the medication, no known prior art exists for keying a dosing container to a medication container. Thus, what is needed is a dosing syringe that is used in combination with a dispensing valve to provide a fluid safety dispenser.

### SUMMARY OF THE INVENTION

The present invention provides a container and keyed fluid dispenser to inhibit inadvertent access to unmeasured quantities of potentially dangerous products, such as medicines, by requiring the user to repeat one or more deliberate steps before fluid can be extracted from the container. The fluid safety dispenser system includes a controllable opening in the container for passage of fluids stored therein. A dispensing valve is positionable in the opening, employing a biasing member wherein an open position allows fluid passage and a closed position prevents fluid passage. A keyed fluid dispenser can be releasably securable to the dispensing valve for use in drawing fluid from the container.

An objective of the instant invention is to disclose a dispensing valve having a biased member forming a controllable flow through chamber; the member can be displaced by a keyed fluid dispenser forming a fluid safety dispenser.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a perspective view of the container and keyed fluid dispenser of the instant invention;

FIG. 2 is a perspective view of the container and keyed fluid dispenser in an engaged configuration;

FIG. 3 is a top view of the valve member;

FIG. 4 is a side view of the valve member;

FIG. 5 is a perspective view of the valve member in a folded position; and

FIG. 6 is a cross-sectional side view of the valve member mounted on a bottle.

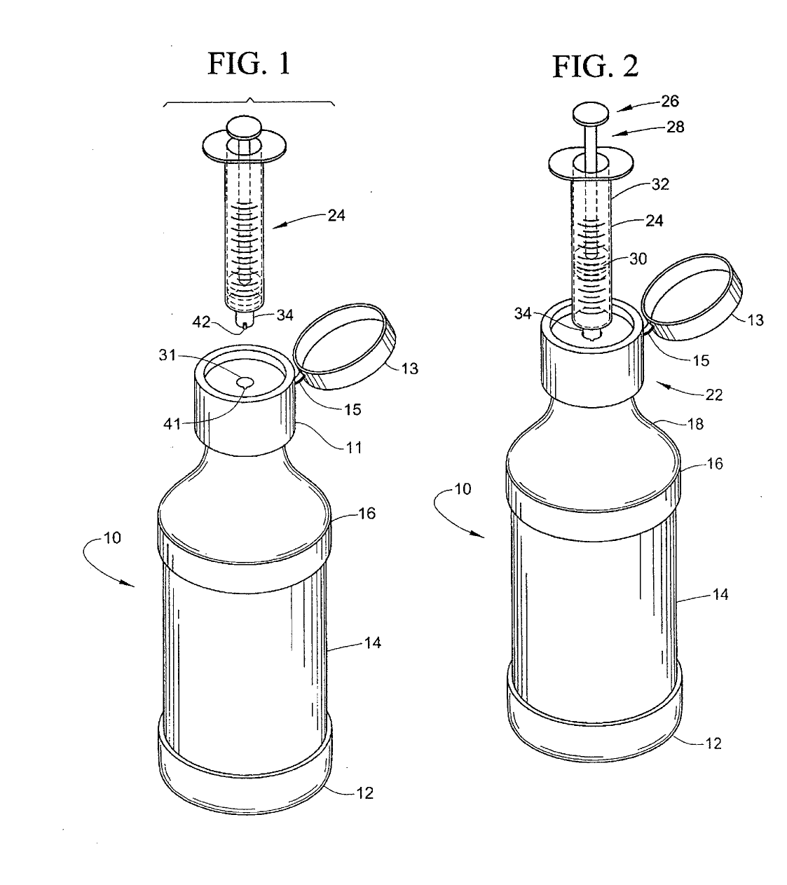

### DETAILED DESCRIPTION OF THE PREFERRED EMBODIMENT

Now referring to the Figures, set forth is a container defined by a bottom 12, a continuous sidewall 14, and an upper section 16. The container may contain most any fluid, but for purposes of illustration, the container detailed in this specification will be a bottle used for storing liquid medicines for children. The upper section 16 of the container resembles a conventional bottle having a mouth 18 with threads for receipt of a threaded cap. A valve assembly 22 is threaded onto the mouth of the container for use in combination with a keyed fluid dispenser 24 allowing controlled retrieval of the fluids stored within the container. The keyed fluid dispenser 24 of the instant invention is defined by a handle 26 having a shaft 28 coupling the handle to a plunger 30 that is used for drawing fluid into the chamber 32 by pulling a vacuum in the dispenser. The end of the keyed fluid dispenser includes a receptacle insert 34 specifically designed to engage the valve assembly 22. But for the receptacle insert, the keyed fluid dispenser assimilates a conventional syringe type device.

The dispenser valve assembly 22 has an aperture 31 for receipt of the receptacle insert 34. In a preferred embodiment, the aperture includes at least one flute 41 which operates as a keying mechanism for receipt of matched tang 42 arranged on the receptacle insert 34. When keyed alike, the flute 41 and tang 42 cooperate to allowing insertion of the receptacle insert for accessing the fluid held within the container 10. Alternatively, the receptacle insert 34 may be sized to create a seal, thereby acting as a keying feature. For instance, the receptacle insert may be 3.5 mm in diameter, thereby requiring an aperture of the same size less a space to allow for a close tolerance coupling. If the aperture is too small, then the receptacle insert will not fit. If the aperture is too large, then the receptacle insert can be inserted but will not be able to draw fluids by vacuum. If the container is inverted with an undersized receptacle insert, fluid will spill around the fluid dispenser.

The keying feature may include both a tang/flute and unique diameter sizing. The dispenser valve assembly includes a body 11 having a threaded inner surface and a lid 13 attached by a living hinge 15. The lid 13 need not be threaded as the valve assembly prevents removal of the fluid contents unless the fluid dispenser is engaged. Rather, the lid prevents debris from collecting around the aperture and is sized to slip on and off an upper portion of the body 11.

The flutes 41 and/or tangs 42 are geometrically arranged to create a mating receptacle and dripless interface. Although simple tangs are depicted, it will be recognized to those skilled in the art that the tangs can be of any shape, size, position, or combination thereof so as to provide a locking mechanism unique to a keyed fluid dispenser having a mating receptacle for either a particular manufacturer, line of products, or type of product.

The keyed fluid dispenser permits a child's guardian to insure that the medication to be dosed to a child can be performed without displacing all medication held in a cabinet or refrigerator. If all medication containers are keyed, only the proper keyed fluid dispensers need be provided, thereby assuring that only the particular medication is utilized. This has particular benefit for medication that must be refrigerated, as it is difficult to hide medication in an unlocked refrigerator, and expensive to have a locked refrigerator for medicine only. Further, most medicine cabinets are unlocked and become a facilitator for selecting the wrong medicine. The keyed fluid dispenser is not affected by temperature and can be left on a counter to provide a visual reminder of medication due. The keyed fluid dispenser would have no other use and preferably be discarded or recycled after use.

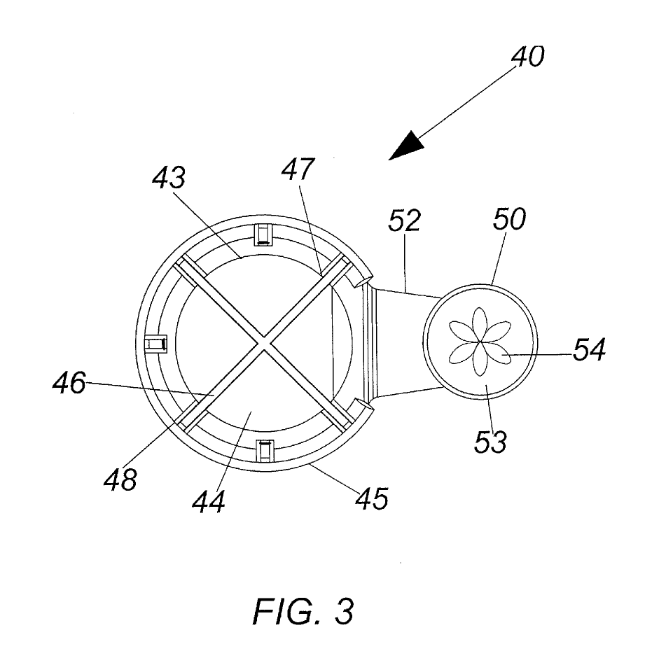

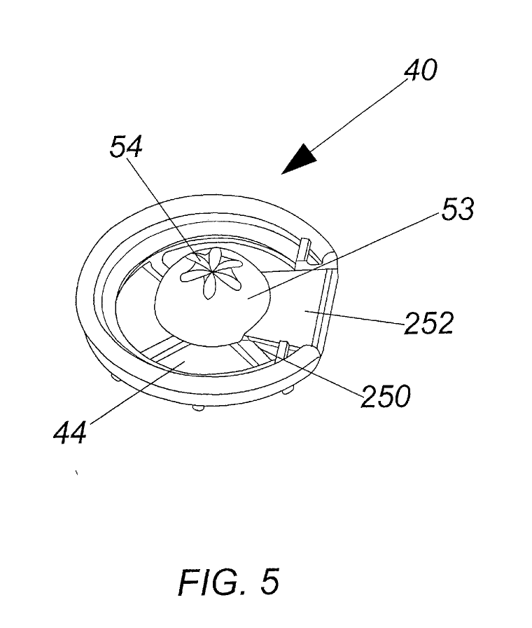

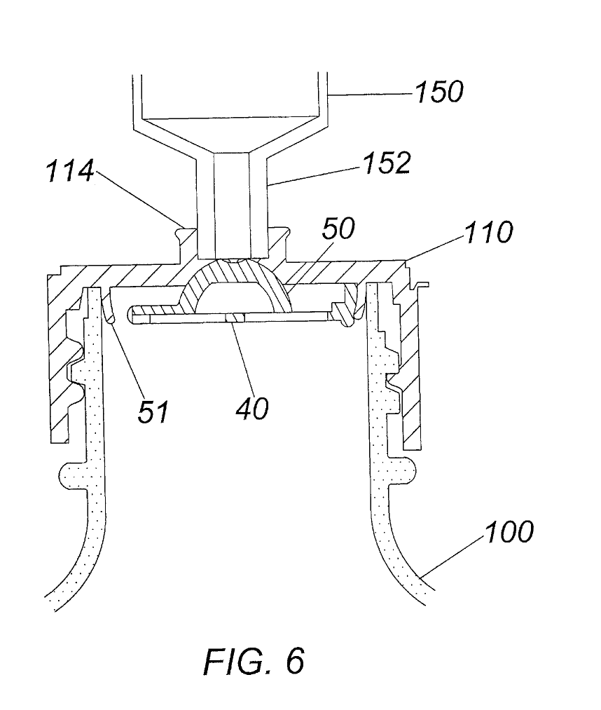

Now referring to FIGS. 3-6, the valve body has a base 40 formed of a single piece of material, preferable plastic. The base 40 is a substantially round disk shaped member having a diameter defined by an outer edge wall 45 securable to along flange member 51. An inner edge wall 43 forms an open area 44 with a bridge support 46 extending from the inner edge 47 on one side of the inner edge wall to an inner edge 48 on the opposite inner edge side. A plug element 50 has a lower surface 60 constructed and arranged to engage the bridge support 46 and an upper surface 54 sized to plug the lower opening of the aperture 114 of cap 110. The bridge support 46 maintains the plug element in contact with the aperture to prevent fluid flow until a displacement of the plug element by a syringe 150 having a fluid connection channel 152 which allows fluid flow. The base 45 and plug element 50 are preferably molded from a single piece of material and adjoined by a living hinge 52. The living hinge 52 is folded over to align the plug element 50 in an aligned position calculated to present the dome shape plug member into the lower opening of the aperture. Channels 54 are formed into the upper surface 53 of the plug member 50 which facilitates fluid flow when the plug element is displaced by a receptacle insert 152. The channels allow ease of fluid flow even if the plug element is only partially displaced.

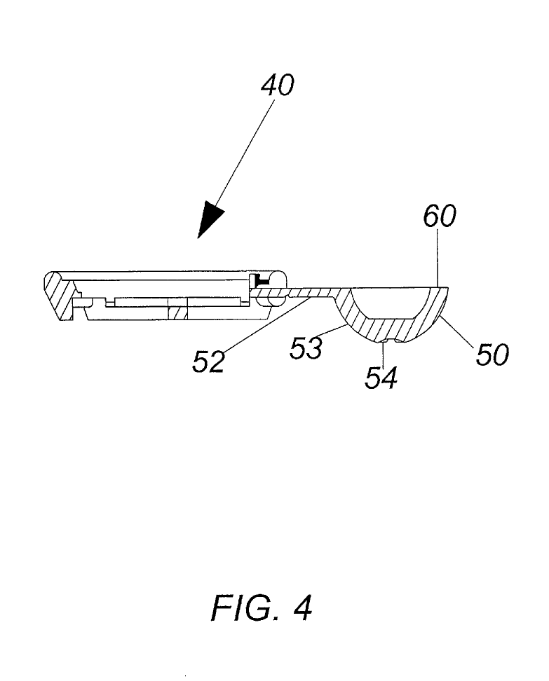

FIG. 2 depicts the valve body 40 with the plug element 50 in a folded position along living hinge 52 with the upper surface 53 of the plug 50 engaging the bridge support 46 which operates as a biasing spring. FIG. 4 depicts the valve body 152 mounted on a bottle 10 with base member 40 secured to the valve body along flange member 41, the flange member 41 surrounds at least a part of the base. The bottle is conventional having a bottom, a continuous sidewall, and a top section that is threaded and used for accessing fluid placed within the bottle. The bottle may contain most any fluid.

The base member 40 is snapped into the flanges with the dome shape portion of plug member 50 facing upward in a position that will seal the aperture 114 from fluid exiting the container. The fluid dispenser 150 has a receptacle insert 152 that fits within the aperture 114 and depresses plug member 50 away from the end of the aperture, displacing the sealing effect and thus allowing fluid to be drawn into

The use of a syringe allows a controlled removal of fluid. This provides further assurance that the fluid is dispensed only in combination with syringe which can be calibrated so that the bottle and the syringe are keyed alike. If the syringe is calibrated to the bottle and material, the instructions can be as simple as stating that fluid drawn must be equal to the second hash line on the syringe.

The embodiments disclose the use of a multi component fluid dispensing valve that, which will be obvious to one skilled in the art, can be made from various manufacturing techniques to lessen the amount of components used. The valve assembly and keyed fluid dispenser provide a lock and key type arrangement for the control of fluids from a container. The use of a keyed fluid dispenser verifies that the amount of fluid drawn is exact with the calibration provided by the manufacturer. For instance, if the fluid drawn is measured in ml, then the indicia on the measuring indicia will be marked appropriately. This provides further assurance that the keyed fluid dispenser can only be used in combination with the container to which fluid is to be drawn and the keyed fluid dispenser would have no other useful purpose. The use of all plastic materials allows the container and keyed fluid dispenser to be recycled.

While detailed embodiments of the instant invention are disclosed herein, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fluid safety dispenser system comprising:
a container having a bottom, a top, and a continuous side wall therebetween for storage of fluids, said top having an opening formed from an inner side wall to provide a passageway for the fluids stored therein;
a valve body positionable in said opening, said valve body having a centrally disposed aperture;
a plug member constructed and arranged to seal said aperture, said plug member is a substantially round disk shaped member having a diameter, said diameter further defined by an outer edge wall securable to said valve body and an inner edge wall with at least one bridge support extending from said inner edge on one side to said inner edge on the opposite side, a lower surface of said plug element engaging said bridge support and an upper surface sized to plug said aperture; and
a fluid dispenser formed from a vessel having a syringe, said vessel including a receptacle insert for displacing said plug from said aperture and drawing fluids from said container.
wherein said bridge support maintains said plug element in contact with said aperture to prevent fluid flow whereby displacement of said plug element allows fluid flow.

2. The fluid safety dispenser system as set forth in claim 1 wherein valve body is constructed and arranged to be sealingly secured to said opening of said container.

3. The fluid safety dispenser system as set forth in claim 1 wherein said fluid dispenser includes measurement indicia to indicate the amount of fluid drawn from said container.

4. The fluid safety dispenser system as set forth in claim 1 wherein said valve body and said plug member are preassembled as an assembly, said assembly insertable into said opening and sealing the fluids held within the container.

5. The fluid safety dispenser system as set forth in claim 1 wherein said disk member and said plug element are constructed from a single piece of material and said plug element is folded onto said bridge support by a living hinge.
